(19) United States
(12) Patent Application Publication
(10) Pub. No.: US 2010/0013984 A1
(43) Pub. Date: Jan. 21, 2010

(54) NONCONDENSING SECURITY CAMERA HOUSING WINDOW ASSEMBLY

(75) Inventor: Dominick F. LOIACONO, Nissequogue, NY (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/433,457

(22) Filed: Apr. 30, 2009

Related U.S. Application Data
(60) Provisional application No. 61/081,098, filed on Jul. 16, 2008.

(51) Int. Cl. H04N 5/225; H04N 7/18

(52) U.S. Cl. 348/373; 348/E07.085; 348/E05.024; 348/143

(57) ABSTRACT

Security video cameras, in either bullet or dome formats, typically suffer from fogging (condensation) on the lens window due to humid weather conditions. The present invention uses a secondary window affixed in close proximity to primary window with a sealed air gap between windows to eliminate the fogging conditions.

### CROSS-REFERENCE TO RELATED APPLICATION

This application claims the benefit of co-pending provisional application 61/081,098 filed on Jul. 16, 2008.

### TECHNICAL FIELD

This invention relates to security camera housing windows, and in particular to a security camera housing window assembly that eliminates condensation due to harsh weather conditions.

### BACKGROUND OF THE INVENTION

Outdoor security video cameras consist of a camera block which is housed in a weatherproof enclosure, whether a bullet design or a dome design. The enclosure employs either a flat, circular optical window (for bullet cameras), or a bubble window (for dome cameras) which in either case is a clear or tinted piece of plastic or glass. Currently, when outdoor cameras are subjected to extreme temperature changes, any humidity that is in the weatherproof enclosure condenses on the inside of the optical window, most often in front of the lens path, and completely obscures the video image, rendering it useless. For example, the most problematic scenario is when it is very hot during the day followed by a cool rain or rapidly falling evening/night temperatures, such as found in Florida or other southern states. Solutions have been attempted by others, including installing humidity control methods such as desiccant packs, and much more expensive and elaborate solutions such as installing air circulating fans, heaters, etc. The present applicant has recently also tried to make enclosures extremely air-tight, but all cameras need internal adjustments during installation, as well as occasionally over their service life, so humidity entering the camera housing is essentially impossible to control.

### DISCLOSURE OF THE INVENTION

To overcome these problems of the prior art, a security camera housing is provided having an enclosure adapted to contain a security camera, and a noncondensing window assembly affixed to the enclosure. The noncondensing window assembly includes a primary window located on the enclosure to allow the security camera to view a region external to the housing, and a secondary window affixed in close proximity to the primary window, with a sealed air gap between the secondary window and the primary window.

### BRIEF DESCRIPTION OF THE DRAWING

FIG. 1 illustrates a front view of window of a prior art bullet security camera.

FIG. 2 illustrates a cross section of a bullet security camera utilizing a noncondensing window assembly of the present invention.

### BEST MODE FOR CARRYING OUT THE INVENTION

As explained above, in the prior art window, condensation often occurs on the inside of the window during environmental temperature drops, which is caused by a large temperature differential on the glass (cold on the outside and warm and humid on the inside). By using a secondary window portion that overlaps the primary window with a sealed air gap as described herein, this problem has been mitigated. The result is that rather than having one large temperature differential on one window, the temperature difference is now spread over two windows as well as the air between them. The air between the two windows is preferably low in humidity to prevent condensation from appearing between the two windows.

Optical windows, which currently are designed and manufactured using a single layer of plastic or glass, are replaced in the current invention with the window assembly having two layers, with an appropriate air gap between them (which may be as little as several millimeters). For video domes, a smaller diameter bubble would be housed over a larger diameter bubble, again with a several millimeter air gap.

The following test methodology was implemented in order to recreate a fogging event. The main procedure (using two temperature/humidity chambers) to test the HONEYWELL HCD92534 bullet cameras was defined as follows:
1. Oven conditioning, 50 degrees C. for 14 hours, 50% RH, followed by
2. Rapid exposure to 15 degrees C. at 95% RH

Other variations on this test were also attempted, but the main point is to have high heat followed by rapid cooling and high relative humidity (RH) creating a vacuum that pulls air/moisture into the camera, should the sealing of the camera not be 100% effective. Whether the camera pulls in moist air or not, the quick drop in temperature causes a large temperature differential on the lens window (warm, moist air inside, and cold air outside). This causes any moist air inside the camera to condense on the inside of the lens window. This type of scenario is likely to occur in rainstorms that induce a sudden drop in temperature in a very short period of time on a hot day. Under these test conditions the current prior art HONEYWELL HCD92534 camera would fog every time it was subjected to this test.

The prior art single pane front plastic bezel fogs as a result of the inside of that mechanical assembly being warm when the outside of the bezel is cooled by the prevailing environmental conditions. This is the same principle that creates condensation on the inside of the glass windows of a warm building in the winter, when the outside temperature is cold.

A dual window assembly was created with a primary window located on the camera housing enclosure to allow the security camera to view the external regions as in the prior art devices, and a secondary window that is affixed in close proximity to the primary window. Preferably there is an approximately 2 mm air gap between the two windows in order to further mitigate the inside/outside temperature difference allowing for greater fog resistance. The dual window assembly was implemented only directly over the lens on the outside of the current window assembly. The same plastic that is currently used on the primary window of the HONEYWELL HCD92534 was used for the secondary window. We did not place the secondary window over the infrared LED's, which are used for illumination in night viewing (this may extend over the LEDs if desired, however). This solution is simple to implement, and for re-work purposes, it would not require disassembly of the camera. There is no change required to the current design of the optical window assembly; it would require an additional step to glue (or double-stick tape) a secondary window onto the baffle on the outside of the primary window of the current assembly. As a result, there was virtually no fog present when it was subjected to the test described above.

The two piece window solution is most effective in eliminating fogging. We have tested the video performance with two windows and the present invention appears to provide video comparable to the standard single-window version of the HCD92534. This new window assembly is preferably put together in a low humidity environment to ensure moisture is not trapped between the two window portions during the assembly process.

Three exemplary embodiments of the invention are a night bullet camera, a day bullet camera, and a dome camera, as now described.

### 1. Night Bullet Camera

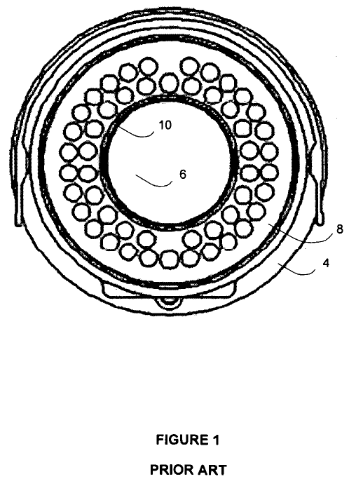

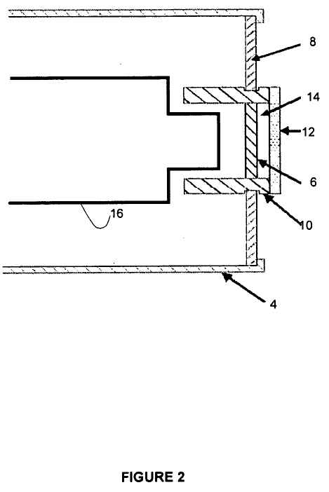

A front view of a night bullet camera is shown in FIG. 1, with the cross section of the present invention shown in FIG. 2. The housing enclosure 4 contains a camera and lens assembly 16, which is located behind a primary window 6. In this embodiment, the primary window 6 is held in place inside of an outer or perimeter LED ring window 8 by a baffle 10 as known in the art. The baffle 10 is raised over the surface of the primary window 6 by a distance of approximately 2 mm. A noncondensing window assembly of the present invention includes the primary window and a secondary window 12 affixed to the baffle 10 as shown to create a sealed air gap 14 between the secondary window 12 and the primary window 6 in accordance with the invention. The noncondensing window assembly is considered to be affixed to the housing enclosure via the LED ring window 8 even though there is no direct connection.

### 2. Day Bullet Camera

The day bullet camera differs from the night bullet camera in that there is no outer LED window 8, only a single primary window 6 extending across the entire front of the camera housing 4. In this case, the secondary window 12 may be attached to the primary window using any means desired, such as a ring glued in place to create the desired air gap, etc.

### 3. Dome Camera

The dome camera as known in the art utilizes a semi-spherical primary window rather than a flat one as in the bullet cameras. In accordance with the invention, the secondary window would have the same general shape as the primary dome window and be affixed in close proximity to the primary dome window in accordance with the invention to provide a sealed air gap as described herein.

I claim:

1. A security camera housing comprising:
an enclosure adapted to contain a security camera; and
a noncondensing window assembly affixed to the enclosure comprising:
a primary window located with respect to enclosure to allow the security camera to view a region external to the housing; and
a secondary window affixed in close proximity to the primary window, with a sealed air gap between the secondary window and the primary window.

2. The security camera housing of claim 1 in which the air gap between the secondary window and the primary window is approximately two millimeters.

3. The security camera housing of claim 1 in which air in the air gap has low humidity.

4. The security camera housing of claim 1 further comprising a baffle affixed between the secondary window and the primary window for providing the sealed air gap between the secondary window and the primary window.

5. A noncondensing security camera housing window assembly comprising:
a primary window configured for installation in a security camera housing enclosure to allow an internally located security camera to view a region external to the housing; and
a secondary window affixed in close proximity to the primary window with a sealed air gap between the secondary window and the primary window.

6. The noncondensing security camera housing window assembly of claim 5 in which the air gap between the secondary window and the primary window is approximately two millimeters.

7. The noncondensing security camera housing window assembly of claim 5 in which air in the air gap has low humidity.

8. The noncondensing security camera housing window assembly of claim 5 further comprising a baffle affixed between the secondary window and the primary window for providing the sealed air gap between the secondary window and the primary window.

9. A method of assembling a noncondensing security camera housing window assembly comprising affixing a secondary window in close proximity to a primary window, the primary window suitable for use with a security camera housing, with an air gap between the secondary window and the primary window.

10. The method of claim 9 wherein the air gap is approximately two millimeters.

11. The method of claim 9 in which air in the air gap has low humidity.

12. The method of claim 9 in which the secondary window is affixed to a baffle which is affixed to the primary window for providing the sealed air gap between the secondary window and the primary window.
